(19) United States
(12) Patent Application Publication
(10) Pub. No.: US 2004/0173049 A1
(43) Pub. Date: Sep. 9, 2004

(54) Transmission mechanism of child bicycle

(76) Inventor: Jun-Cheng Chen, Taichung Hsien (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/377,742

(22) Filed: Mar. 4, 2003

(51) Int. Cl. G05G 1/14

(52) U.S. Cl. 74/594.1

(57) ABSTRACT

A ratchet based transmission mechanism mounted in a wheel for a child bicycle is disclosed. In a propelling of the bicycle a pawl is pushed against a tooth, a ratchet disk rotates as both pawl blocks and a transmission disk rotate, and the ratchet disk is secured in a bore of the wheel. When a rotation speed of the wheels is faster than a rotation speed of pedals, the pawl blocks will be pushed inward by the teeth for disengaging the ratchet disk from the transmission disk for stopping the pedals while maintaining the rotation of the wheels. This can prevent a skid from occurring while the bicycle is running on a downhill road or accelerating.

### FIELD OF THE INVENTION

The present invention relates to transmission mechanism of a bicycle and more particularly to an improved transmission mechanism for a child bicycle for preventing a skid from occurring.

### BACKGROUND OF THE INVENTION

A conventional transmission mechanism mounted in a wheel for a child bicycle is shown in FIGS. 1 and 2. As shown, a tire 13 is fixed about a rim of a wheel 11. A bore 15 is formed at a hub of the wheel 11. Three elongated projections 17 are equally spaced apart around an interior surface of the bore 15. Each elongated projection 17 has a threaded hole 19 therethrough. Two abutment disks 23 are provided wherein one abutment disk 23 is formed around a crank 25 by welding. Each abutment disk 23 has three through holes equally spaced apart around its peripheral edge. Six screws are driven through the holes on the abutment disks 23 and the threaded holes 19 to fasten the abutment disks 23 to the bore 15. As known that a driver can rotate pedals 27 to propel the bicycle.

However, the prior art transmission mechanism suffered from a disadvantage. For example, a rotation speed of the wheels can be faster than a speed that the driver rotates the pedals 27 when the bicycle is running on a downhill road or accelerating. In other words, a skid occurs at this time. This can cause danger to the driver (e.g., a child). Thus, the need for improvement still exists.

### SUMMARY OF THE INVENTION

It is therefore an object of the present invention to provide a transmission mechanism for a child bicycle for preventing a skid from occurring while the bicycle is running on a downhill road or accelerating.

To achieve the above and other objects, the present invention provides a wheel for a child bicycle comprising, in combination a bore formed at a hub of the wheel; a plurality of elongated projections equally spaced apart around an interior surface of the bore, each projection having a threaded hole therethrough; and a transmission mechanism comprising, at either side of the wheel, a crank passed through the bore, a transmission disk sleeved on the crank, the transmission disk including a circumferential groove, two opposite troughs perpendicular to the circumferential groove, two arcuate slots perpendicular to the circumferential groove and abutted the troughs, and a stop on the circumferential groove in the middle of the slots, two opposite pawl blocks each including a slope, an arcuate section positioned in the slot, a pawl, and a central groove aligned with the circumferential groove, a C-shaped elastic ring put on the grooves for preventing the pawl blocks from disengaging from the transmission disk while permitting the pawl blocks to have a defined pivot about the slots, the stop being positioned in the opening of the C-shaped elastic ring for preventing a rotational movement of the C-shaped elastic ring in the grooves from occurring, a ratchet disk including a plurality of equally spaced apart recesses around a peripheral surface thereof so as to matingly engage with the elongated projections, a central opening with the crank passed through and the assembled C-shaped elastic ring, the transmission disk, and the pawl blocks fitted therein, and a plurality of teeth on an interior surface sloped in one direction, each tooth being engaged with the pawl, each tooth including a wall, a flat disk at outside of the transmission disk being fastened onto the crank, an abutment disk fitted on a mouth of the bore, the abutment disk including a central hole with the crank passed through, a plurality of fasteners driven through a surface of the abutment disk to secure in the threaded holes, a convex member around the central hole, and a bearing received in an inner concave portion of the convex member, the bearing being fitted on the crank; wherein in a propelling of the bicycle the pawl is pushed against the tooth and stopped by the wall, the ratchet disk rotates as both the pawl blocks and the transmission disk rotate, and the ratchet disk is secured in the bore so that when a rotation speed of the wheels is faster than a rotation speed of the crank, the pawl blocks will be pushed inward by the teeth for disengaging the ratchet disk from the transmission disk for stopping the crank while maintaining the rotation of the wheels.

The above and other objects, features and advantages of the present invention will become apparent from the following detailed description taken with the accompanying drawings.

### BRIEF DESCRIPTION OF THE DRAWINGS

FIG. 1 is an exploded view of a conventional transmission mechanism for child bicycle;

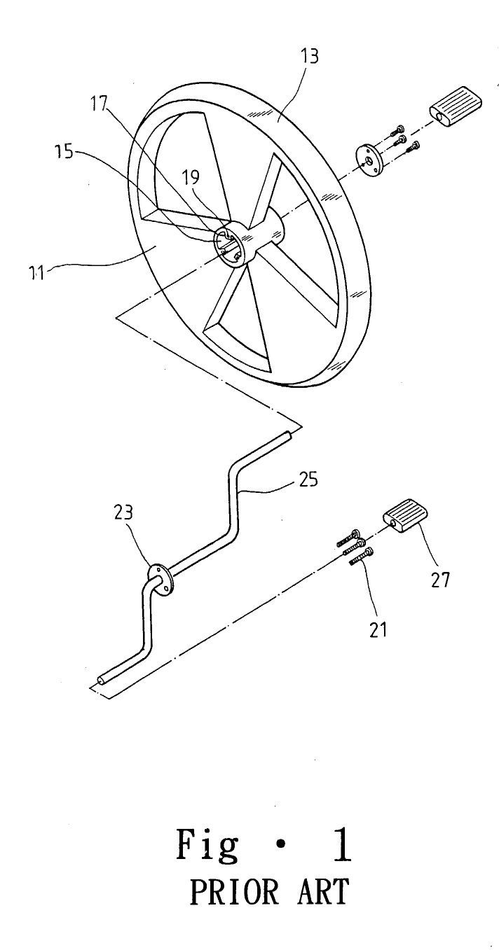

FIG. 2 is a cross-sectional view of the FIG. 1 transmission mechanism;

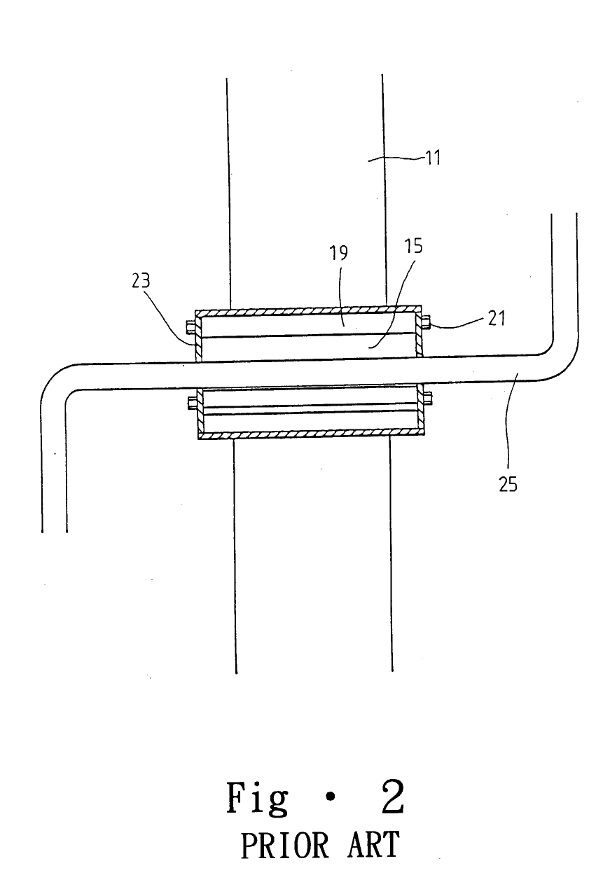

FIG. 3 is an exploded view of a transmission mechanism for child bicycle according to the invention;

FIG. 4 is a cross-sectional view of the assembled ratchet disk, C-shaped elastic ring, transmission disk, two pawl blocks, and other associated components; and

FIG. 5 is an exploded view of the ratchet disk, the transmission disk, and the pawl blocks.

### DETAILED DESCRIPTION OF THE PREFERRED EMBODIMENTS

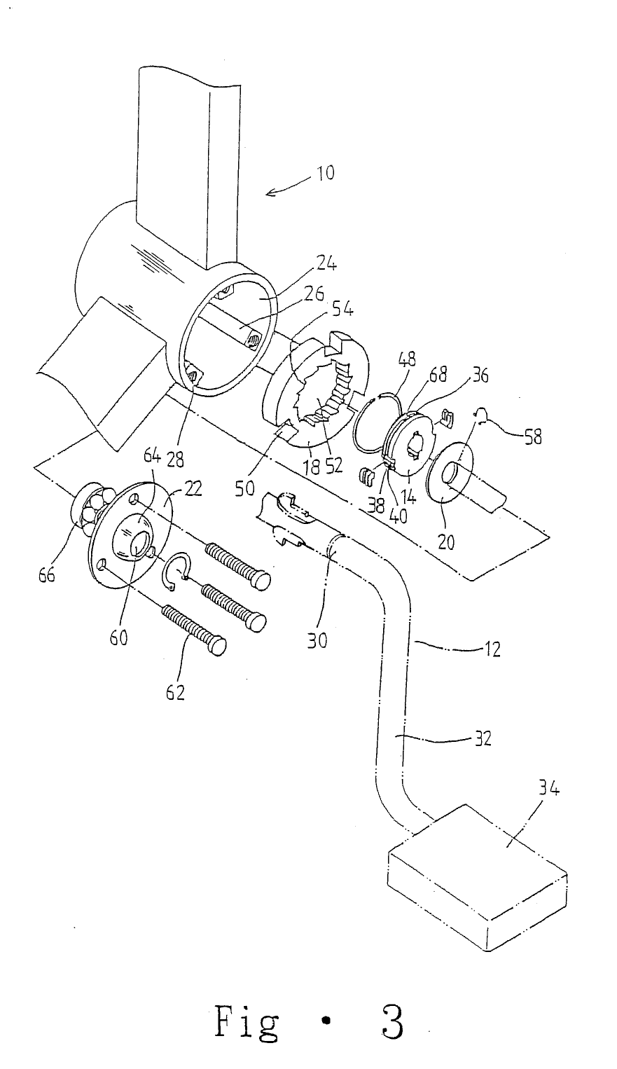

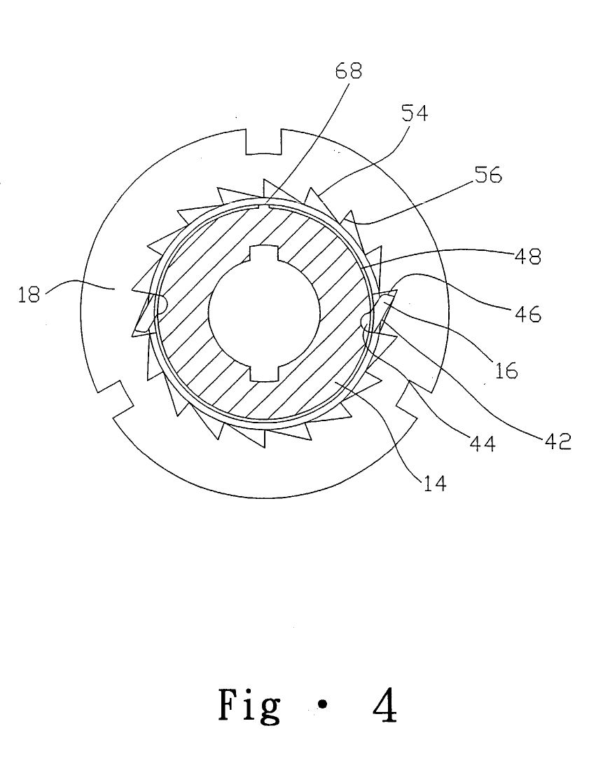

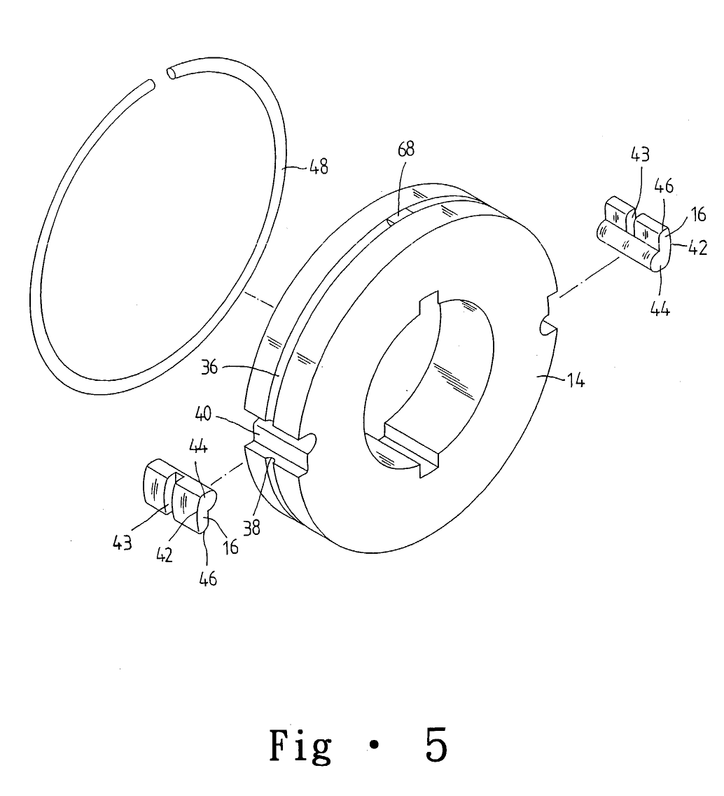

Referring to FIGS. 3, 4, and 5, there is shown a transmission mechanism mounted in a wheel for a child bicycle constructed in accordance with the invention. Components of the transmission mechanism and associated components of the bicycle are described in detail below. A tire (not shown) is fixed about a rim of a wheel 10. A bore 24 is formed at a hub of the wheel 10. Three elongated projections 26 are equally spaced apart around an interior surface of the bore 24. Each elongated projection 26 has a threaded hole 28 therethrough. Note that the following description is about components at one side of the wheel 10 while components at the other side thereof will not be described in detail since they are mirror images of the components at one side of the wheel 10. A crank 12 has a central horizontal member 30 passed through the bore 23 and a vertical member 32 with a pedal 34 mounted on an open end of the vertical member 32. A transmission disk 14 is sleeved on the horizontal member 30. The transmission disk 14 comprises a circumferential groove 36, two opposite troughs 38 perpendicular to the groove 36, two arcuate slots 40 also perpendicular to the groove 36 and abutted the troughs 38, and a stop 68 on the groove 36 in the middle of the slots 40. Two opposite pawl blocks 16 are provided each including a slope 42, an arcuate section 44 positioned in the slot 40, a pawl 46, and a central groove 43 aligned with the groove 36. A C-shaped elastic ring 48 is put on the grooves 36 and 43 for preventing the pawl blocks 16 from disengaging from the transmission disk 14 while permitting the pawl blocks 16 to have a limited pivot about the slots 40. Also, the stop 68 is located in the opening of the ring 48 for preventing a rotational movement of the ring 48 in the grooves 36 and 43 from occurring. A ratchet disk 18 comprises three equally spaced apart recesses 50 around its peripheral surface so as to matingly engage with the elongated projections 26 in the bore 24, a central opening 52 with the horizontal member 30 passed through and the assembly of the ring 48, the transmission disk 14, and the pawl blocks 16 fitted therein, and a plurality of teeth 54 on an interior surface sloped in one direction, each tooth 54 being engaged with the pawl 46 of the pawl block 16. Each tooth 54 comprises a wall 56. A flat disk 20 is provided at an outer side of the transmission disk 14. A C-shaped clip ring 58 is used to fasten the flat disk 20 onto the horizontal member 30. An abutment disk 22 is fitted on the mouth of the bore 24. The abutment disk 22 comprises a central hole 60 with the horizontal member 30 passed through, three screws 62 driven through its surface to secure in the threaded holes 28, a convex member 64 around the central hole 60, and a bearing 66 received in an inner concave portion of the convex member 64, the bearing 66 being fitted on the horizontal member 30.

In operation, a child rotates the pedals 34 to propel the bicycle. At this time, the pawl 46 of the pawl block 16 is pushed against the tooth 54 and stopped by the wall 56. As such, the ratchet disk 18 rotates as both the pawl blocks 16 and the transmission disk 14 rotate. The ratchet disk 18 is in turn secured in the bore 24. Hence, the wheel 10 also rotates. In a case that a rotation speed of the wheels 10 is faster than a speed that the driver rotates the pedals 34 while the bicycle is running on a downhill road or accelerating. The pawl blocks 16 will be pushed inward by the teeth 54. As such, a rotation of the ratchet disk 18 is disengaged from the transmission disk 14. As a result, a stop of the crank 12 can be carried out while the wheels 10 are running. In other words, a skid will not occur. This can increase safety to the driver while driving.

While the invention has been described by means of specific embodiments, numerous modifications and variations could be made thereto by those skilled in the art without departing from the scope and spirit of the invention set forth in the claims.

What is claimed is:

1. A wheel for a child bicycle comprising, in combination:
a bore formed at a hub of the wheel;
a plurality of elongated projections equally spaced apart around an interior surface of the bore, each projection having a threaded hole therethrough; and
a transmission mechanism comprising, at either side of the wheel, a crank passed through the bore, a transmission disk sleeved on the crank, the transmission disk including a circumferential groove, two opposite troughs perpendicular to the circumferential groove, two arcuate slots perpendicular to the circumferential groove and abutted the troughs, and a stop on the circumferential groove in the middle of the slots, two opposite pawl blocks each including a slope, an arcuate section positioned in the slot, a pawl, and a central groove aligned with the circumferential groove, a C-shaped elastic ring put on the grooves for preventing the pawl blocks from disengaging from the transmission disk while permitting the pawl blocks to have a defined pivot about the slots, the stop being positioned in the opening of the C-shaped elastic ring for preventing a rotational movement of the C-shaped elastic ring in the grooves from occurring, a ratchet disk including a plurality of equally spaced apart recesses around a peripheral surface thereof so as to matingly engage with the elongated projections, a central opening with the crank passed through and the assembled C-shaped elastic ring, the transmission disk, and the pawl blocks fitted therein, and a plurality of teeth on an interior surface sloped in one direction, each tooth being engaged with the pawl, each tooth including a wall, a flat disk at outside of the transmission disk being fastened onto the crank, an abutment disk fitted on a mouth of the bore, the abutment disk including a central hole with the crank passed through, a plurality of fasteners driven through a surface of the abutment disk to secure in the threaded holes, a convex member around the central hole, and a bearing received in an inner concave portion of the convex member, the bearing being fitted on the crank;
wherein in a propelling of the bicycle the pawl is pushed against the tooth and stopped by the wall, the ratchet disk rotates as both the pawl blocks and the transmission disk rotate, and the ratchet disk is secured in the bore so that when a rotation speed of the wheels is faster than a rotation speed of the crank, the pawl blocks will be pushed inward by the teeth for disengaging the ratchet disk from the transmission disk for stopping the crank while maintaining the rotation of the wheels.
